(19) United States
(12) Patent Application Publication
(10) Pub. No.: US 2008/0101220 A1
(43) Pub. Date: May 1, 2008

(54) Header suppression/compression apparatus and method for providing multicast and broadcast service (MBS) in broadband wireless access system

(75) Inventors: Ki-Back Kim, Seongnam-si (KR); Jae-Woo Kim, Suwon-si (KR); Sung-Hong Wie, Yongin-si (KR)

Correspondence Address: DOCKET CLERK, P.O. DRAWER 800889, DALLAS, TX, 75380, US

(73) Assignee: SAMSUNG ELECTRONICS Co., LTD., Suwon-si (KR)

(21) Appl. No.: 11/981,932

(22) Filed: Oct. 31, 2007

(30) Foreign Application Priority Data
Oct. 31, 2006 (KR) 2006-0106261
Oct. 31, 2006 (KR) 2006-0106403

(51) Int. Cl. H04L 12/24

(52) U.S. Cl. 370/229

(57) ABSTRACT

Header suppression/compression apparatus and method for providing Multicast and Broadcast Service (MBS) in a Broadband Wireless Access (BWA) system are provided. The method includes checking an overhead ratio of a packet based on the MBS channels; when the overhead ratio of the packet is greater than a threshold, compressing a header of the packet according to a compression algorithm preset for the corresponding MBS channel or zone; and when the overhead ratio of the packet is less than the threshold, uncompressing the header of the packet.

### CROSS-REFERENCE TO RELATED APPLICATION(S) AND CLAIM OF PRIORITY

The present application claims priority under 35 U.S.C. § 119(a) to an application filed in the Korean Intellectual Property Office on Oct. 31, 2006 and assigned Serial No. 2006-0106403, and an application filed in the Korean Intellectual Property Office on Oct. 31, 2006 and assigned Serial No. 2006-0106261, the contents of which are incorporated herein by reference.

### TECHNICAL FIELD OF THE INVENTION

The present invention relates generally to a Multicast and Broadcast Service (MBS) in a broadband wireless access system, and in particular, to a header suppression/compression apparatus and method for providing MBS based on MBS channels and zones.

### BACKGROUND OF THE INVENTION

In general, communication systems have been developed based on a voice service and are now advancing to providing data service and various multimedia services as well as the voice service. The voice oriented communication systems have not satisfied users' service needs because of their relatively narrow transmission bandwidths and expensive fees. Additionally, advances of the communication industry and users' increasing demand for Internet service raise the necessity for communication systems that efficiently provide Internet service. To respond to this demand, a Broadband Wireless Access (BWA) system is presented with enough broadband to meet the users' increasing demand for an efficiently provided Internet service.

The BWA system integrally supports not only a voice service, but also multimedia application services such as various low-speed and high-speed data services and high-definition video. The BWA system is a radio communication system capable of accessing a Public Switched Telephone Network (PSTN), a Public Switched Data Network (PSDN), the Internet, an International Mobile Telecommunications (IMT)-2000 network, and an Asynchronous Transfer Mode (ATM) network in a mobile or stationary environment based on radio media using broadbands of 2 GHz, 5 GHz, 26 GHz, and 60 GHz, and supporting a data transfer rate over 2 Megabits per second (Mbps). The BWA system can be classified to a broadband wireless subscriber network, a broadband mobile access network, and a high-speed wireless Local Area Network (LAN) based on the terminal mobility (stationary or mobile), the communication environment (indoor or outdoor), and the channel transfer rate.

The radio access scheme of the BWA system is standardized by Institute of Electrical and Electronics Engineers (IEEE) 802.16 Working Group, which is an international standardization organization.

Compared to a conventional radio technique for the voice service, the IEEE 802.16 standard can transfer much data within a shorter time with the wide data bandwidth and allow all users to efficiently share and utilize the channel (or resource). Also, with Quality of Service (QoS) guaranteed, the users can enjoy services of different qualities according to the service characteristics.

An IEEE 802.16 system has a Multicast and Broadcast Service (MBS) specification for providing the multicast and the broadcast to a plurality of mobile terminals. The MBS can be called MCBCS according to the intention of its standardization group or its administrator. The MBS_ZONE is a region including a single sub-cell or a plurality of sub-cells which send the same broadcast channels over the same frequency at the same time. The sub-cells in the MBS_ZONE use the same broadcast channel and the same Connection Identifier (CID) for the contents. The sub-cell is a group of a frequency and a sector. A base station (BS) broadcasts MBS_ZONE information using a Downlink Channel Descriptor (DCD) message. Note that the MBS zone can be constituted by a single base station or a plurality of base stations.

The MBS can multicast or broadcast broadcasting contents to every terminal within the MBS zone which provides a specific broadcasting service. The characteristic of the 802.16 system enables not only a unidirectional downlink broadcasting service but also a bidirectional connection through an uplink connection.

Capacity required for the MBS flows varies: 32 Kbps, 64 Kbps, 128 Kbps, 256 Kbps, 384 Kbps, 500 Kbps, and 1 Mbps. The capacity below 64 Kbps is mostly used for providing contents such as audio or text messages as the MBS. The typical video and audio service required capacity used in Digital Multimedia Broadcasting (DMB) is 384 Kbps. The 128 Kbps service is used to provide a low-definition video service. The capacity over 1 Mbps is used to provide a high-definition video service. Generally, the MBS varies the channel constitution and the data rate according to the MBS zone.

The channel conditions in a wireless network keep changing according to time, position and moving velocity of the terminal, because of multipath fading and shadowing. Getting close to a cell edge, the inter-cell interference is increased, thereby obstructing the radio data reception. The MBS can acquire a combining diversity effect by grouping the entire BS into MBS zones to which multiple BSs can belong according to their zones such that the BSs in the same MBS zone send the same content at the same time. To attain the combining diversity effect, the content transmission over the air requires time and content synchronization. Diversity through synchronization is called macro-diversity. In the MBS, the same broadcast service channel can be transmitted not only by multiple base stations in the same MBS zone but also from the different several MBS zones. In case of one broadcast service flow, when the ratio of the overhead to the pure payload size is high, considerable wastes of the backhaul resource and the air resource are caused.

When a base station (BS) controller or an upper stage has a time stamping function for the synchronization, the BS controller (or the upper stage) is responsible for a data copy function. The BS controller separately includes a queue which stores streams coming down from a MBS server according to the broadcast channels. However, every transmit packet has a 40-byte header (=Internet protocol (IP)+User Datagram Protocol (UDP)+Routing Table Protocol (RTP)). Since the service flows with the required capacity below 128 Kbps sent every frame, they have a payload below 80 bytes. Therefore, without the header suppression and compression, the resource waste over 50% is caused to both of the backhaul and the air.

Accordingly, the suppression and compression is required according to the flow transmission requirements (e.g., Payload Header Suppression (PHS) or RObust Header Compression (ROHC)). Using PHS, the 40-byte header can be compressed into 24 bytes. Using the ROHC, the U-mode can compress the 40-byte header up to 5 bytes at maximum. In terms of the compression processing capacity, the ROHC has the more complicated implementation and has greater waste than the PHS. While the compression rate of the ROHC is much higher than that of the PHS, the performance of the ROHC greatly deteriorates under the radio environment suffering much error.

However, as for the MBS, when the compression schemes are applied according to both of the MBS zone and the broadcast channel at the same time, the number of cases of applying the compression exponentially increases according to the number of the MBS zones and the number of the channels. In addition, the entire MBS efficiency differs depending on the service required capacity and the processing capacity for the compression. More specifically, with respect to the several different MBS zones broadcasting the same content, if a certain zone does the compression and a certain zone does not do the compression, even the same content requires a plurality of queues for the header compressions methods; that is, for the uncompression, the PHS, and the ROHC or needs to compress the header every time it constitutes a data size to be transmitted over the air according to the MBS zone. However, the plurality of the queues causes wastes of memory and processing capacity. The header compression in every constitution of the data size to be transmitted over the air complicates its implementation and drastically increases the processing capacity in proportion to the number of the MBS zones because the applied compression methods based on the MBS zone differ with respect to one queue which stores the uncompressed contents.

### SUMMARY OF THE INVENTION

To address the above-discussed deficiencies of the prior art, it is a primary object of the present invention to substantially solve at least the above problems and/or disadvantages and to provide at least the advantages below. Accordingly, an aspect of the present invention is to provide a header suppression/compression apparatus and method for providing an MBS based on MBS channels and MBS zones in a BWA system.

Another aspect of the present invention is to provide an apparatus and method for mitigating complexity of implementation and decreasing waste of a processing capacity by separately including compression queues according to a required capacity of the service channels and supportability of the terminal when a header for efficient MBS based on MBS channels and MBS zones is compressed in a BWA system.

The above aspects are achieved by providing a header suppression/compression method for providing a MBS in a wireless access system, which includes checking an overhead ratio of a packet based on the MBS channels; when the overhead ratio of the packet is greater than a threshold, compressing a header of the packet according to a compression algorithm preset for the corresponding MBS channel or zone; and when the overhead ratio of the packet is less than the threshold, uncompressing the header of the packet.

According to one aspect of the present invention, a header suppression/compression apparatus for providing a MBS in a wireless access system includes an MBS server for receiving and outputting an MBS channel packet from a content provider; and a BS controller for, when receiving the MBS channel packet from the MBS server, determining whether an MBS terminal supports a header compression function, checking an overhead ratio of the packet based on the MBS channels when the MBS terminal supports the header compression function, compressing a header of the packet according to a compression algorithm preset for a corresponding MBS channel or zone when the overhead ratio of the packet is greater than a threshold, and uncompressing the header of the packet when the overhead ratio of the packet is less than the threshold.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 depicts a network for providing an MBS in a BWA system according to the present invention;

FIG. 2 depicts a header suppression/compression method for providing the MBS based on MBS channels in the BWA system according to the present invention; and

FIG. 3 depicts a header suppression/compression method for providing the MBS based on MBS zones in the BWA system according to the present invention.

### DETAILED DESCRIPTION OF THE INVENTION

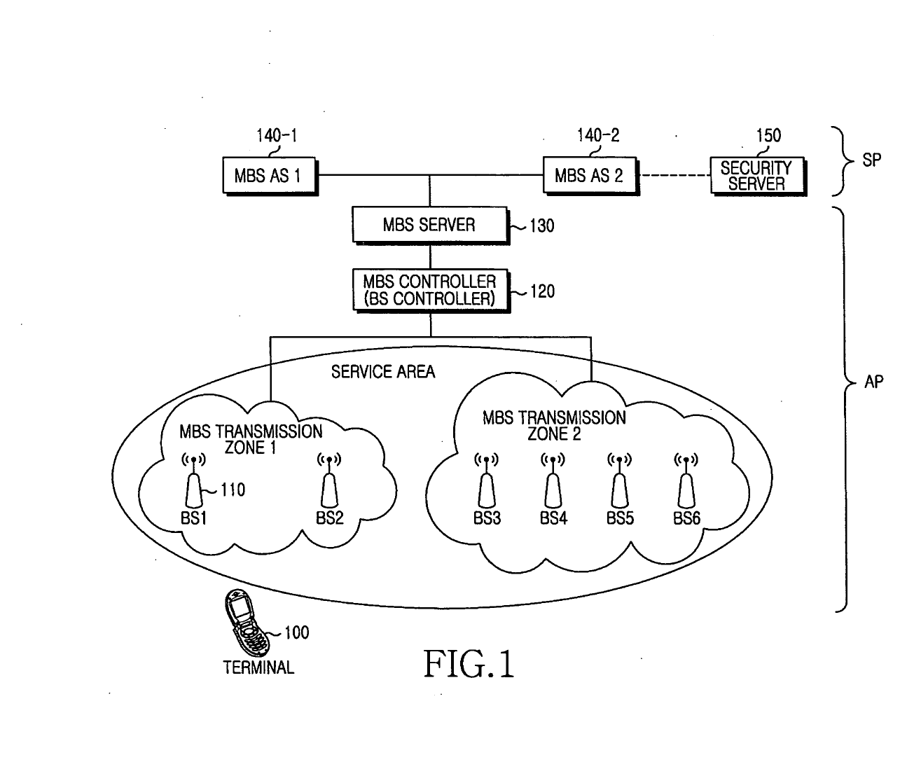

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

The present invention provides a header suppression and compression apparatus and method for providing a Multicast and Broadcast Service (MBS) in a Broadband Wireless Access (BWA) system.

Hereafter, while a base station (BS) controller of the BWA system compresses a header for the MBS by way of example, an MBS server can compress the header for the MBS according to an entity which synchronizes time and contents.

According to the present invention, the decision whether to compress the header or not for the MBS service is determined depending on a provider requirement and a condition of a terminal. Specifically, when every terminal for receiving the MBS provides a compression function, the BS controller compresses a header of the corresponding packet and stores the compressed header to a queue in advance every time the packet is received from the MBS server. When a provider provides the MBS even to the terminal which does not provide the compression function, the header compression is not applied when the packet is stored to the queue.

Whether to compress the header for the MBS is flexibly determined according to the ratio of the overhead (IP+UDP+RTP overhead) to the pure payload size of the packet transmitted from the MBS server to the BS controller. When the ratio of the overhead is high, the compression algorithm, such as ROHC, having the high compression rate is applied while the waste of the processing capacity is considerable. When the ratio of the overhead is medium, the compression algorithm, such as PHS, having the medium processing capacity waste and the proper compression rate is applied. When the overhead ratio is low, the compression is not applied. The compression algorithm can be applied by taking into account the ranging of the compression algorithm supported by the terminal. For example, when the overhead ratio of the packet is high and the terminal does not support the compression algorithm with the high compression rate such as ROHC, the PHS compression algorithm supportable by the terminal is applied or the compression is not applied at all.

The transmission rate of the channels and the compression algorithm are pre-determined according to the transmission rate of the channels and the supportability of the terminal's compression function. According to the present invention, it is assumed that the transmission rate of the packet based on the MBS channels is constant. If the transmission rate varies, the compression algorithm applied to the corresponding MBS channel or zone can be changed according to the transmission rate.

Note that the present invention is applicable to a single base station (BS) as well as the multiple base stations.

In the following explanation, the name of a network entity (NE) is defined according to the corresponding function and thus may vary according to the intention of the standardization group or the administrator. For example, a base station (BS) can be called a radio access station (RAS) and a BS controller may be called an access control router (ACR) or an access service network-gateway (ASN-GW). Herein, the ASN-GW can function as a router as well as the BS controller.

Entities relating to the MBS are now described.

The entities related to the MBS are as follows. Typically, the entities related to the MBS include a content provider (CP), an MBS service provider (SP), an access provider (AP), and a user.

The CP produces and provides MBS content. The SP receives the content from the CP and services the content to a user for free or after receiving a fee from the user. The AP transmits the service of the SP to the user. While the CP, the SP, and the AP can be independent providers, a single provider may act as all of the three providers or as two or more providers. An example of the single provider is a terrestrial broadcasting provider in South Korea.

FIG. 1 depicts a network for providing an MBS in a BWA system according to the present invention.

The network of FIG. 1 includes a security server 150, MBS Application Servers (ASs) 140-1 and 140-2, an MBS Server 130, an MBS controller 120, a base station (BS) 110, and a terminal 100. Herein, the MBS controller 120 may be an independent device positioned together with a BS controller, or the BS controller may function as the MBS controller 120.

The security server 150 authenticates and authorizes a user who wants to subscribe for the MBS.

The MBS ASs 140-1 and 140-2 belong to a coverage of the SP. To ensure the functions of the SP, the MBS ASs 140-1 and 140-2 are in charge of a subscription processing/managing function for the user who subscribed to the SP, a function for sending the MBS contents to the AP, a user authentication function for an access control of an illegal user, a function for protecting contents provided from the CP, a function for managing terminals of users, and a function for providing information necessary for the MBS. In FIG. 1, a difference between the first MBS AS 140-1 and the second MBS AS 140-2 is that the first MBS AS 140-1 is for the SP which provides free service or does not provide the illegal user control function and the content protection function, and that the second MBS AS 140-2 is for the SP which provides the pay service, the illegal user control function, and the content protection function. The functions of the MBS AS 140 are described in further detail as below:

1) generate MBS information (e.g., a service guide): comply with a data model agreed among the MBS ASs when generating the service guide;

2) perform a subscription procedure for the user's MBS reception;

3) authenticate and authorize the user, and process the charging in association with the security server 150;

4) manage user groups based on MBS channels or MBS contents;

5) manage and distribute authentication keys based on groups;

6) illegal user access control/multimedia service and content protection: manage and distribute content encryption and decryption keys;

7) stream transmission/file transmission: define a transmission protocol, manage a reception report for confirming whether the user normally receives the MBS contents, and manage a file metadata for file transmission;

8) user interaction: provide interaction service with user; and

9) notification/alert: when a broadcast schedule is changed or an emergency broadcasting is required, provide a service for informing the MBS subscribed user of such an event.

The MBS Server 130 is the central entity in the AP. The MBS Server 130 aggregates and transmits the MBS service information (e.g., service guide) from the multiple SPs, manages the network resources for its efficient utilization, and supports error-free data reception at the user terminal, which are described in further detail below:

1) manage MBS zone: manage a BS in a zone to be serviced based on the SPs.

2) process the service guide: aggregate the service guide received from the MBS AS, fragment the service guide if necessary, compress the service guide for reducing the network resource consumption, and maintain and manage the service guide;

3) distribute the service guide: unicast or multicast;

4) stream transmission/file transmission: confirm whether the user normally receives the MBS contents (in some cases, perform the same function as the MBS AS);

5) manage a multicast group by locating the user; and

6) process the reception report: when the user report the network condition using the reception report, reflect the reception report.

The MBS controller 120 is positioned in the AP. The MBS controller 120 supports a function for efficiently forwarding the MBS received through a central network over a radio network by interconnecting the central network and an access network and a function for informing the user terminal of the MBS service start, which are described in further detail:

1) synchronize data/time for providing a macro diversity gain: reserve and allocate bursts and process packets;

2) manage MBS zones; and

3) forward group paging information for notification.

According to the present invention, the MBS controller 120 compresses a header of a packet received from the MBS Server 130 using a compression algorithm of the MBS channel according to a ratio of an overhead to the pure overhead size of the packet and whether the terminal supports the compression function or not, and pre-stores the compressed header to a corresponding compression algorithm queue. Alternatively, the MBS controller 120 compresses the header of the packet received from the MBS Server 130 according to the overhead ratio of the packet using a compression algorithm of the MBS zone where the corresponding MBS is received, and pre-stores the compressed header in a corresponding compression algorithm queue. Next, to process data, the MBS controller 120 extracts the data stored to the corresponding compression algorithm queue based on the MBS channels or the MBS zones, packetizes the data in accordance with a burst size to be transmitted over the air, copies the packetized packet, and transmits the packet to the base stations belonging to the same MBS zone.

The BS 110 wirelessly transmits the MBS received by cable. The BS 110 is managed by the AP.

The terminal 100, which is a user terminal, provides the user with the MBS received through the network entities.

In FIG. 1, the service area indicates a coverage where the SP provides the service. The MBS transmission zone, which is a transmission management region defined by the AP for the efficient MBS transmission, indicates a coverage where the same contents are broadcast. By contrast, the MBS zone indicates a coverage where the MBS flow is effective through different Connection IDentifiers (IDs) or different Security Associations (SAs).

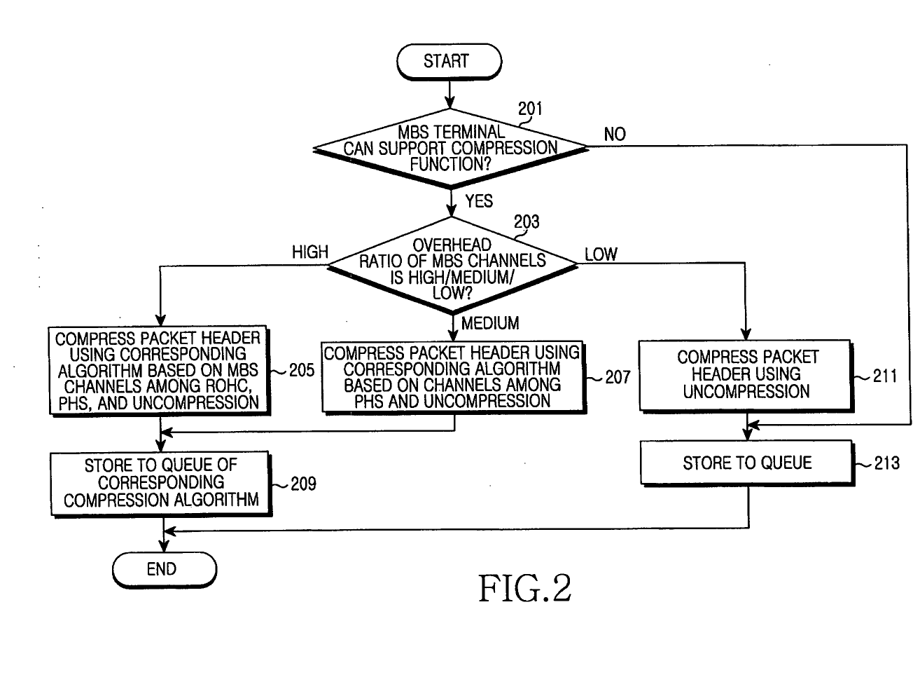

FIG. 2 depicts a header suppression/compression method based on MBS channels in the BWA system according to the present invention.

In FIG. 2, the BS controller determines whether the MBS terminal supports the compression function or not in step 201. Herein, the determining whether the terminal supports the compression function may be omitted by the provider (that is, the unsupportable terminal may not watch the broadcasting), or the provider may acquire whether the terminal supports the compression function in advance and inform the BS controller of the supportability. Since it is expected that every terminal provides the header compression function, the supportability determination will be omitted accordingly. When the MBS terminal supports the compression function, the BS controller examines whether the ratio of the overhead to the pure payload size of the packet received from the MBS Server; that is, the ratio of the overhead to the pure payload size of the packet of the MBS channels (MBS flows) is high, medium, or low in step 203. The overhead ratio of the packet varies depending on the transmission rate of the corresponding packet. For example, the overhead ratio increases at the low transmission rate and decreases at the high transmission rate. Herein, the overhead of the packet is determined using the sum of the IP header, the UDP header, and the RTP header. Whether the overhead ratio is high, medium or low is determined based on thresholds. For example, when the overhead ratio is greater than a first threshold, the corresponding overhead ratio is high. When the overhead ratio is less than the first threshold and greater than a second threshold, the corresponding overhead ratio is medium. When the overhead ratio is less than the second threshold, the corresponding overhead ratio is low.

The BS controls includes a different number of queues for the packet overhead ratios. The queue stores the packet with the compressed header according to the corresponding algorithm.

For instance, the BS controller can assign three queues for the high packet overhead ratio, two queues for the medium packet overhead ratio, and one queue for the low packet overhead ratio. The three queues allocated for the high packet overhead ratio include a ROHC queue for storing ROHC-processed packets, a first PHS queue for storing PHS-processed packets, and a first unpressed queue for storing uncompressed packets. The two queues allocated for the medium packet overhead ratio include a second PHS queue for storing PHS-processed packets and a second uncompressed queue for storing uncompressed packets. The one queue allocated for the low packet overhead ratio includes a third uncompressed queue for storing uncompressed packets. Herein, in the high packet overhead ratio, the three allocated queues do not require considerable memory resource because their transmission ratios are quite low. Likewise, considerable memory resource is not required at the medium packet overhead ratio.

When the overhead ratio of the packet received from the MBS Server is high in step 203, the BS controller compresses the header of the packet using the compression algorithm of the corresponding MBS channel in step 205 and then stores the header-compressed packet to the queue of the corresponding compression algorithm in step 209. The compression algorithm includes the ROHC, the PHS, and the uncompression. Specifically, the header-compressed packet using the ROHC is stored to the ROHC queue, the header-compressed packet using the PHS is stored to the first PHS queue, and the header-compressed packet using the uncompression is stored to the first uncompressed queue. Herein, the packet header compression using the uncompression denotes that the header of the packet is not compressed at all.

When the overhead ratio of the packet received from the MBS Server is medium in step 203, the BS controller compresses the header of the packet using the compression algorithm of the corresponding MBS channel in step 207 and then stores the header-compressed packet to the queue of the corresponding compression algorithm in step 209. In doing so, the compression algorithm includes the PHS and the uncompression. That is, the header-compressed packet using the PHS is stored to the second PHS queue, and the header-compressed packet using the uncompression is stored to the second uncompressed queue.

When the overhead ratio of the packet received from the MBS Server is low in step 203, the BS controller compresses the header of the packet using the uncompression in step 211 and then stores the header-compressed packet to the third uncompressed queue in step 213.

By contrast, when the MBS terminal does not support the compression function in step 201, the BS controller just stores the corresponding packet to the third uncompressed queue in step 213.

Afterwards, in the data processing, the BS controller extracts the data stored to the corresponding compression algorithm queue based on the MBS channels, packetizes the data in accordance with the burst size to be sent over the air, and duplicates and transmits the packetized packet to the BSs in the same MBS zone. Therefore, every MBS data transmitted from the BSs in the same MBS zone can be synchronized.

Next, the BS finishes this process.

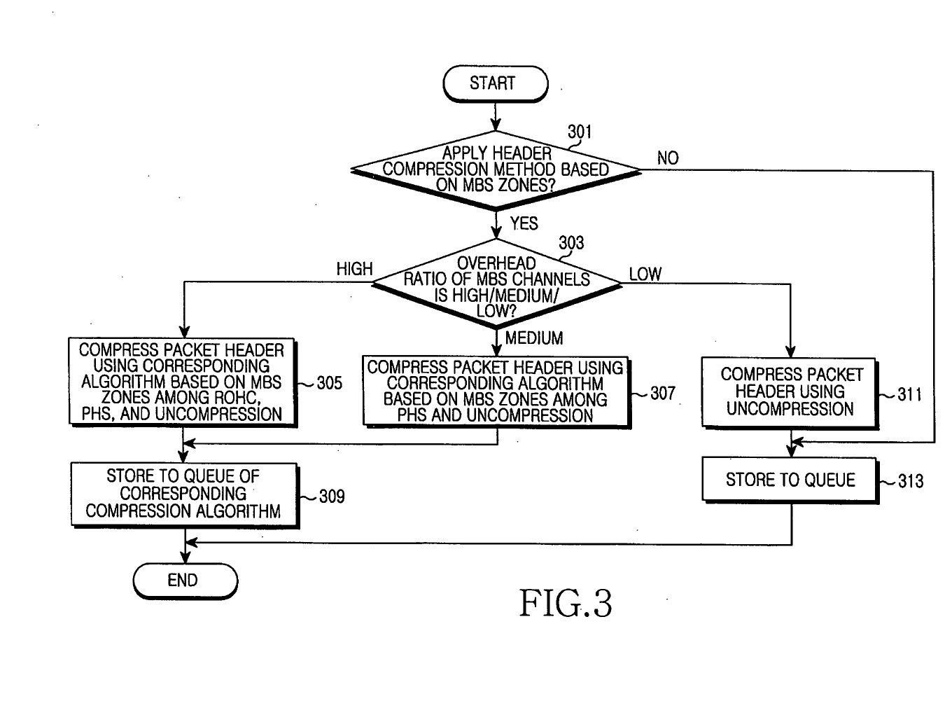

FIG. 3 depicts a header suppression/compression method for providing the MBS based on MBS zones in the BWA system according to the present invention.

The compression algorithms to be applied to the respective MBS zones are preset by the provider according to the service and the terminal condition. For example, to transmit multiple broadcasting contents to a specific MBS zone, the provider can set the compression algorithm such as ROHC in the corresponding MBS zone to compress the broadcasting contents at a high compression rate. When a specific MBS zone does not support the compression algorithm such as ROHC, the provider can set the compression algorithm of the low compression rate, such as PHS, for the corresponding MBS zone.

Referring to FIG. 3, the BS controller determines whether to apply the header compression method based on the MBS zones in step 301. When determining to apply the header compression method based on the MBS zones, the BS controller examines the overhead ratio of the packet received from the MBS Server; that is, the BS controller checks whether the overhead ratio of the packet based on the MBS channels (the MBS service flows) is high, medium, or low in step 303. The overhead ratio of the packet differs depending on the data rate of the corresponding packet. For example, at the low transmission rate, the overhead ratio is high. At the high transmission rate, the overhead ratio is low. Herein, the overhead of the packet is defined as the sum of an IP header, a UDP header, and an RTP header.

The BS controller includes the different number of queues according to the packet overhead ratios. The queue stores the header-compressed packet according to the corresponding algorithm. For example, the BS controller can allocate three queues for the high packet overhead ratio, two queues for the medium packet overhead ratio, and one queue for the low packet overhead ratio. The three queues allocated to the high packet overhead ratio include a ROHC queue for storing a ROHC-processed packet, a first PHS queue for storing a PHS-processed packet, and a first uncompressed queue for storing an uncompressed packet. The two queues allocated to the medium packet overhead ratio include a second PHS queue for storing a PHS-processed packet and a second uncompressed queue for storing an uncompressed packet. The queue allocated to the low packet overhead ratio includes a third uncompressed queue for storing an uncompressed packet. Although three queues are allocated for the high packet overhead ratio, it does not require great memory resource because its transmission rate is quite low. Likewise, the medium packet overhead ratio does not require considerable memory resource.

When the overhead ratio of the packet received from the MBS Server is high in step 303, the BS controller compresses the packet header using the compression algorithm of the MBS zone where the corresponding MBS is received in step 305 and stores the header-compressed packet in the queue of the corresponding compression algorithm in step 309. In doing so, the compression algorithm includes the ROHC, the PHS, and the uncompression. In specific, the packet compressed using the ROHC is stored to the ROHC queue, the packet compressed using the PHS is stored to the first PHS queue, and the packet compressed using the uncompression is stored to the first uncompressed queue. Note that the packet header compression using the uncompression denotes that the header of the packet is not compressed at all.

When the overhead ratio of the packet received from the MBS Server is medium in step 303, the BS controller compresses the packet header using the compression algorithm of the MBS zone where the corresponding MBS is received in step 307 and stores the header-compressed packet to the queue of the corresponding compression algorithm in step 309. In doing so, the compression algorithm includes the PHS and the uncompression. More specifically, the packet compressed using the PHS is stored to the second PHS queue and the packet compressed using the uncompression is stored to the second uncompressed queue.

When the overhead ratio of the packet received from the MBS Server is low in step 303, the BS controller compresses the packet header using the uncompression in step 311 and stores the header-compressed packet to the second uncompressed queue in step 313.

By contrast, when determining not to apply the header compression method based on the MBS zones in step 301, the BS controller goes to step 313 to store the corresponding packet to the second uncompressed queue.

To process the data, the BS controller extracts the data stored to the corresponding compression algorithm queue based on the MBS zones, packetizes the data in accordance with the burst size to be transmitted over the air, copies the packetized packet, and sends the copied packets to the BSs in the same MBS zone. Thus, the MBS data transmitted by every BS in the same MBS zone is synchronized.

Next, the BS controller finishes this process.

In the meantime, depending on the provider's policy, the MBS server may pre-determine whether to compress the packet header and the compression type by checking the overhead ratio of the packet based on the MBS channels and comparing the overhead ratio of the packet with the thresholds. In this case, the MBS server transmits the information relating to the determined compression and the determined compression type to the BS controller and the BS controller executes the compression according to the received information. To inform the terminal of the information relating to the determined compression and the determined compression type, if the BS controller informs of the determined information, the MBS server may include the information as service guide contents and send the information through the application layer, or insert the information into a Dynamic Service x (DSx) message. As for the PHS, since a PHS Index (PHSI) field is appended to the head of the Service Data Unit (SDU), the MAC layer of the terminal can recognize the information without having to pass through the application layer.

As set forth above, the header suppression/compression apparatus and method for providing the efficient MBS based on the MBS channels or the MBS zones in the BWA system can drastically reduce the backhaul and air resources by lowering the overhead ratio of the MBS traffics transmitted through both the backhaul and the air, and provide the optimized MBS through the efficient resource utilization. Further, when the header is compressed based on the MBS channels or the MBS zones, the compression queue is separately provided according to the service channel required capacity and the terminal's supportability, to thus mitigate the implementation complexity and reduce the waste of the processing capacity.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A header suppression/compression method for providing a Multicast and Broadcast Service (MBS) in a wireless access system, the method comprising:
checking an overhead ratio of a packet based on the MBS channels;
when the overhead ratio of the packet is greater than a threshold, compressing a header of the packet according to a compression algorithm preset for the corresponding MBS channel or zone; and
when the overhead ratio of the packet is less than the threshold, uncompressing the header of the packet.

2. The header suppression/compression method of claim 1, further comprising:
storing the header-compressed packet to a corresponding compression algorithm queue.

3. The header suppression/compression method of claim 1, further comprising:
storing the header-uncompressed packet to a queue.

4. The header suppression/compression method of claim 1, further comprising:
when an MBS terminal does not support a header compression function, uncompressing the header of the packet and storing the header-uncompressed packet to a queue.

5. The header suppression/compression method of claim 1, wherein the overhead of the packet is set to a sum of at least one of an Internet Protocol (IP) header, a User Datagram Protocol (UDP) header, and a Routing Table Protocol (RTP) header.

6. The header suppression/compression method of claim 1, wherein the overhead ratio is a size of the overhead in relation to a size of a pure payload of the packet.

7. The header suppression/compression method of claim 1, wherein the compression algorithm preset for the MBS channels or zones is one of a Payload Header Suppression (PHS), a RObust Header Compression (ROHC), and an uncompression.

8. The header suppression/compression method of claim 1, wherein the compression algorithm based on the MBS channels or zones is preset according to a transmission ratio of the channels and according to whether the terminal supports the compression function.

9. The header suppression/compression method of claim 8, wherein a compression algorithm of a high compression rate is set for a corresponding channel or zone when the transmission rate is less than a first threshold, a compression algorithm of a low compression rate is set for a corresponding channel or zone when the transmission rate is greater than the first threshold and less than a second threshold, the uncompression is set for a corresponding channel or zone when the transmission rate is greater than the second threshold, and an algorithm having a compression ratio lower than a corresponding compression algorithm is applied to a corresponding channel or zone or the compression algorithm is not applied when the terminal does not support the compression algorithm set based on the transmission rate.

10. The header suppression/compression method of claim 2, further comprising:
packetizing the stored packet in accordance with a burst size to be sent over the air, duplicating and transmitting the packetized packet to Base Stations (BSs) belonging to the same MBS zone.

11. The header suppression/compression method of claim 3, further comprising:
packetizing the stored packet in accordance with a burst size to be sent over the air, duplicating and transmitting the packetized packet to Base Stations (BSs) belonging to the same MBS zone.

12. The header suppression/compression method of claim 4, further comprising:
packetizing the stored packet in accordance with a burst size to be sent over the air, duplicating and transmitting the packetized packet to Base Stations (BSs) belonging to the same MBS zone.

13. The header suppression/compression method of claim 1, further comprising:
transmitting the information on the compression of the packet header and the type of the compression algorithm to the terminal.

14. The header suppression/compression method of claim 13, wherein a service guide including the information is transmitted, or the information is transmitted using DSx (Dynamic Service x) message or PHSI (PHS Index) field of SDU (Service Data Unit).

15. A header suppression/compression apparatus for providing a Multicast and Broadcast Service (MBS) in a wireless access system, the apparatus comprising:
an MBS server for receiving and outputting an MBS channel packet from a content provider; and
a base station controller for, when receiving the MBS channel packet from the MBS server, determining whether an MBS terminal supports a header compression function, checking an overhead ratio of the packet based on the MBS channels when the MBS terminal supports the header compression function, compressing a header of the packet according to a compression algorithm preset for a corresponding MBS channel or zone when the overhead ratio of the packet is greater than a threshold, and uncompressing the header of the packet when the overhead ratio of the packet is less than the threshold.

16. The header suppression/compression apparatus of claim 15, wherein the base station controller stores the header-compressed packet to a corresponding compression algorithm queue and stores the header-uncompressed packet to another queue.

17. The header suppression/compression apparatus of claim 15, wherein the compression algorithm preset for the MBS channels or zones is one of a Payload Header Suppression (PHS), a RObust Header Compression (ROHC), and an uncompression.

18. The header suppression/compression apparatus of claim 15, wherein, when the MBS terminal does not support the header compression function, the base station controller does not compress the header of the packet and stores the header-uncompressed packet to the queue.

19. The header suppression/compression apparatus of claim 15, wherein the overhead of the packet is set to a sum of at least one of an Internet Protocol (IP) header, a User Datagram Protocol (UDP) header, and a Routing Table Protocol (RTP) header.

20. The header suppression/compression apparatus of claim 15, wherein the overhead ratio is a size of the overhead in relation to a size of a pure payload of the packet.

21. The header suppression/compression apparatus of claim 15, wherein the compression algorithm based on the MBS channels or zones is preset according to a transmission ratio of the channels and according to whether the terminal supports the compression function.

22. The header suppression/compression apparatus of claim 21, wherein a compression algorithm of a high compression rate is set for a corresponding channel or zone when the transmission rate is less than a first threshold, a compression algorithm of a low compression rate is set for a corresponding channel or zone when the transmission rate is greater than the first threshold and less than a second threshold, the uncompression is set for a corresponding channel or zone when the transmission rate is greater than the second threshold, and an algorithm having a compression ratio lower than a corresponding compression algorithm is applied to a corresponding channel or zone or the compression algorithm is not applied when the terminal does not support the compression algorithm set based on the transmission rate.

23. The header suppression/compression apparatus of claim 16, wherein the base station controller packets the stored packet in accordance with a burst size to be sent over the air, duplicates and transmits the packetized packet to BSs belonging to the same MBS zone.

24. The header suppression/compression apparatus of claim 18, wherein the base station controller packets the stored packet in accordance with a burst size to be sent over the air, duplicates and transmits the packetized packet to BSs belonging to the same MBS zone.

25. The header suppression/compression apparatus of claim 15, wherein the BS controller transmits the information on the compression of the packet header and the type of the compression algorithm to the MBS server, the MBS server transmits a service guide including the information or transmits the information using DSx (Dynamic Service x) message or PHSI (PHS Index) field of SDU (Service Data Unit), to the terminal.
